(19) United States
(12) Patent Application Publication
(10) Pub. No.: US 2004/0157476 A1
(43) Pub. Date: Aug. 12, 2004

(54) Perimeter sealed high density multi-pin connector

(76) Inventors: Ralph Maldonado, Temecula, CA (US); Thomas Mowry, Cardiff, CA (US); Peter Kurbikoff, San Diego, CA (US)

Correspondence Address: KIRKPATRICK & LOCKHART LLP, 535 SMITHFIELD STREET, PITTSBURGH, PA, 15222, US

(21) Appl. No.: 10/365,583

(22) Filed: Feb. 12, 2003

(51) Int. Cl. H01R 12/00

(52) U.S. Cl. 439/66

(57) ABSTRACT

An electrical connector is disclosed. The electrical connector includes a base having an array portion and a perimeter portion connected to the array portion. The electrical connector also includes an electrical conductor imbedded into the base. The perimeter portion is formed with a first recess and includes a first sealing member connected to the first recess such that when a first component is connected to the electrical connector the first sealing member forms a seal between the electrical connector and the first component.

### BACKGROUND

The present invention pertains generally to high density multi-pin connectors for electrically connecting the contacts of a first component to the contacts of a second component. More specifically, the present invention pertains to a perimeter sealed high density multi-pin connector.

An electrical connector having a plurality of electrical conductors can be used to connect one electronic component such as a microprocessor to another electronic component such as a printed circuit board. In modern equipment, electrical connectors capable of simultaneously connecting large numbers of electrical circuits from one electronic component to another are often required. Typically, for such an application, the electrical connector includes a frame having two opposed contact surfaces. Each contact surface on the electrical connector is provided for engagement with a corresponding contact surface on one of the electronic components. The frame functions to secure the positions of the electrical conductors relative to one another and to electrically isolate the electrical conductors from one another. In addition, the frame generally incorporates features for mechanically attaching the electronic components thereto.

In certain applications, electrical connectors and the components connected thereto must operate in a harsh environment. Contact surfaces exposed to the harsh environment can experience corrosion, and the corrosion of the contact surfaces can ultimately lead to failure of the contact. One approach that has been used in such applications has been to plate the contact surfaces with heavy gold to minimize the negative effects associated with harsh environments. However, the use of heavy gold plating can be a relatively expensive solution.

### SUMMARY

In one general respect, the present invention is directed to an electrical connector. According to one embodiment, the electrical connector includes a base having an array portion and a perimeter portion connected to the array portion. The electrical connector also includes an electrical conductor imbedded into the base. The perimeter portion includes a first recess structured and arranged to receive a first sealing member such that when a first component is connected to the electrical connector the first sealing member forms a seal between the electrical connector and the first component.

According to another embodiment, the electrical connector includes a base having an array portion and a perimeter portion connected to the array portion. The electrical connector also includes an electrical conductor imbedded into the base. In this embodiment, the perimeter portion is formed with a first recess and includes a first sealing member connected to the first recess such that when a first component is connected to the electrical connector the first sealing member forms a seal between the electrical connector and the first component.

In another general respect, the present invention is directed to a system. According to one embodiment, the system includes an electrical connector that includes a base and an electrical conductor imbedded into the base. The base includes an array portion and a perimeter portion connected to the array portion. The perimeter portion includes first and second recesses. The system also includes first and second components connected to the electrical connector, a first sealing member positioned within the first recess and forming a seal between the electrical connector and the first component, and a second sealing member positioned within the second recess and forming a seal between the electrical connector and the second component.

According to another embodiment, the system includes an electrical connector and first and second components connected to opposite sides of the electrical connector. The electrical connector includes a base and an electrical conductor imbedded into the base. The base includes an array portion and a perimeter portion connected to the array portion. The perimeter portion includes a first sealing member connected to a first recess and forming a seal between the electrical connector and the first component, and a second sealing member connected to a second recess and forming a seal between the electrical connector and the second component.

### BRIEF DESCRIPTION OF THE DRAWINGS

FIG. 1 is a side view of a portion of an electrical connector according to one embodiment of the present invention;

FIG. 2 is a side view of a portion of a system which includes the electrical connector of FIG. 1;

FIG. 3 is a side view of a portion of an electrical connector according to another embodiment of the present invention;

FIG. 4 is a side view of a portion of a system which includes the electrical connector of FIG. 3;

FIG. 5 is a perspective view of one embodiment of the electrical connector of FIG. 1;

FIG. 6 is an enlarged view of a portion of the electrical connector of FIG. 1; and

FIG. 7 shows one embodiment of the electrical conductor of the electrical connector of FIG. 1.

### DESCRIPTION OF THE INVENTION

It is to be understood that the figures and descriptions of the present invention have been simplified to illustrate elements that are relevant for a clear understanding of the present invention, while eliminating, for purposes of clarity, other elements. Those of ordinary skill in the art will recognize, however, that these and other elements may be desirable. However, because such elements are well known in the art, and because they do not facilitate a better understanding of the present invention, a discussion of such elements is not provided herein.

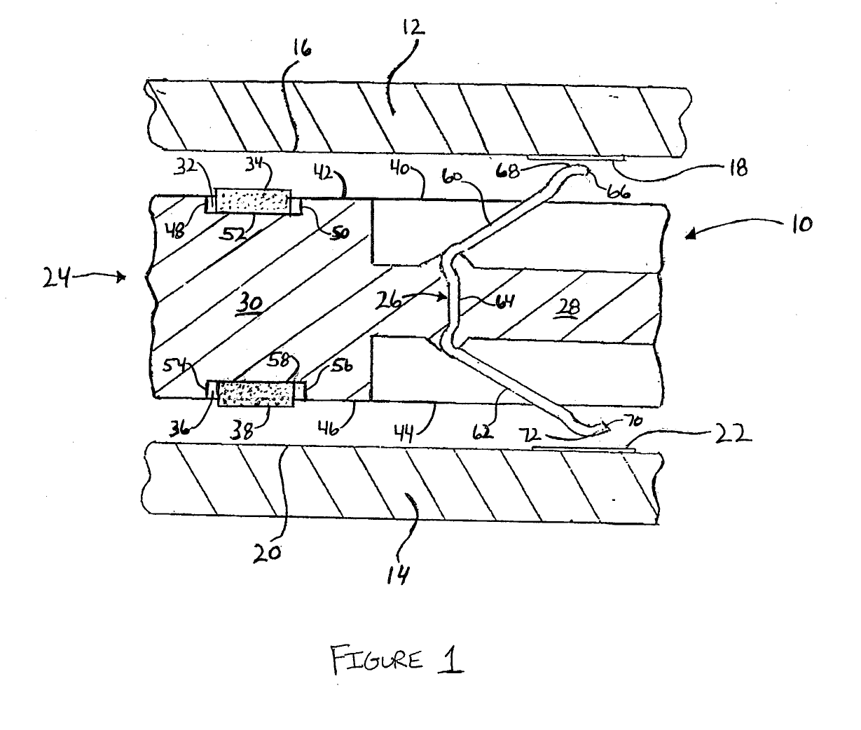

FIG. 1 is a side view of a portion of an electrical connector 10 according to one embodiment of the present invention. To facilitate the description of the electrical connector 10, a portion of a first component 12 and a portion of a second component 14 are also shown in FIG. 1. The first and second components 12, 14 may be, for example, computer microprocessors, application specific integrated circuit (ASIC) devices, printed circuit boards (PCBs) or any other electrical component requiring an electrical connection with another electrical component. The electrical connector 10 may be used, for example, to electrically connect the first component 12 with the second component 14, and may alternatively be referred to as a “microprocessor connector,” a “socket,” an “interposer” or a “land grid array” (LGA) socket.

The first component 12 may include a first side 16 and a first contact 18 connected to the first side 16 of the first component 12. Similarly, the second component 14 may include a first side 20 and a first contact 22 connected to the first side 20 of the second component 14. The first and second contacts 18, 22 can be lands/pads of various shapes and sizes. For example, at least one of the first and second contacts 18, 22 may be a land having a rectangular shaped flat surface. According to other embodiments, the first and second contacts 18, 22 can be fabricated as balls or lands having a VIA hole.

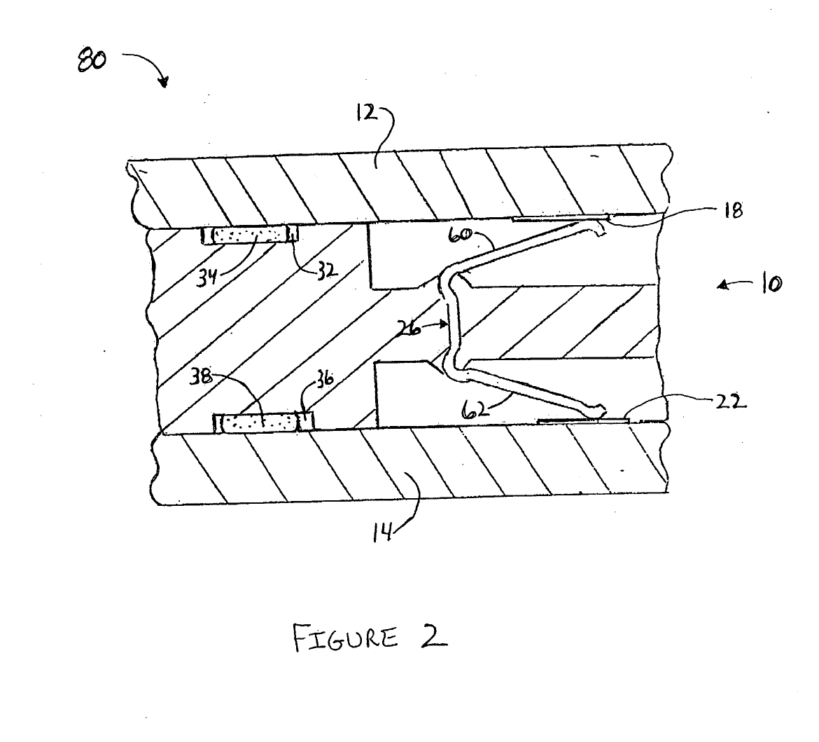

The electrical connector 10 includes a base 24 and an electrical conductor 26 imbedded into the base 24. The base 24 includes an array portion 28 and a perimeter portion 30 connected to the array portion 28. The perimeter portion 30 includes a first recess 32 structured and arranged to receive a first sealing member 34 (shown in FIG. 2) such that when a first component 12 is connected to the electrical connector 10 the first sealing member 34 forms a seal between the electrical connector 10 and the first component 12. The perimeter portion 30 also includes a second recess 36 structured and arranged to receive a second sealing member 38 (shown in FIG. 2) such that when a second component 14 is connected to the electrical connector 10 the second sealing member 38 forms a seal between the electrical connector 10 and the second component 14.

The base 24 includes a first side 40 having a first surface 42 and a second side 44 having a second surface 46. The first side 40 of the base 24 is opposite the second side 44 of the base 24. According to one embodiment, the first side 40 may be considered the top side of the base 24, the first surface 42 may be considered the upper surface of the base 24, the second side 44 may be considered the bottom side of the base 24 and the second surface 46 may be considered the lower surface of the base 24. The base 24 may be fabricated from a rigid, substantially dielectric, non-conducting material such as, for example, a thermoplastic, and the shape, size and design of the base 24 can be varied to be compatible with a particular first component 12 and a particular second component 14.

The first recess 32 of the perimeter portion 30 is defined by the first surface 42 of the base 24, and includes a first sidewall 48, a second sidewall 50 and a floor 52. The second recess 36 of the perimeter portion 30 is defined by the second surface 46 of the base 24, and includes a first sidewall 54, a second sidewall 56 and a floor 58. According to one embodiment, the floor 52 may be positioned approximately 0.005 inches to 0.020 inches below the first surface 42 of the base 24, and the floor 58 may be positioned approximately 0.005 inches to 0.020 inches below the second surface 46 of the base 24. The array portion 28 and the perimeter portion 30 of the base 24 will be described in more detail hereinbelow.

The electrical conductor 26 includes a first finger 60, a second finger 62 and a midsection 64 connecting the first finger 60 to the second finger 62. The first finger 60 extends from the midsection 64 toward the first surface 42 of the base 24 and terminates in a first tip 66. The first finger 60 also includes a first curled contact surface 68 for direct contact with the first contact 18 of the first component 12. The second finger 62 extends from the midsection 64 toward the second surface 46 of the base 24 and terminates in a second tip 70. The second finger 62 also includes a second curled contact surface 72 for direct contact with the first contact 22 of the second component 14. As shown in FIG. 1, the first finger 60 extends beyond the first surface 42 of the base 24 and the second finger 62 extends beyond the second surface 46 of the base 24. The midsection 64 of the electrical conductor 26 is imbedded into the array portion 28 of the base 24.

The electrical conductor 26 may be fabricated from any suitable electrically conductive metal spring material. According to one embodiment, the electrical conductor 26 is stamped or formed from a strip that is approximately 0.001 to 0.003 inches in thickness. In addition, portions of the electrical conductor 26, or the entire electrical conductor 26, may be completely or selectively gold-plated on one side to a thickness of between 3 and 50 micro-inches to enhance the conductivity of the electrical conductor 26.

The first and second sealing members 34, 38 may be any type of sealing member suitable for forming a seal between two components when the two components are physically connected to one another. For example, at least one of the first and second sealing members 34, 38 may be a rubber o-ring or a rubber rectangular-ring. As shown in FIG. 1, prior to connection of the first component 12 to the electrical connector 10, the first sealing member 34 may be friction fit into the first recess 32 such that the first sealing member 34 extends beyond the first surface 42 of the base 24. Similarly, prior to connection of the second component 14 to the electrical connector 10, the second sealing member 38 may be friction fit into the second recess 36 such that the second sealing member 38 extends beyond the second surface 46 of the base 24.

FIG. 2 is a side view of a portion of a system 80 which includes the electrical connector 10 of FIG. 1. The system 80 also includes a first component 12 connected to the first side 40 of the electrical connector 10 and a second component 14 connected to the second side 44 of the electrical connector 10. The first and second components 12, 14 may be as described hereinabove. The system 80 further includes first and second sealing members 34, 38, which may be as described hereinabove.

As shown in FIG. 2, the first sealing member 34 is positioned within the first recess 32 and has been compressed by the first component 12 to form a seal between the electrical connector 10 and the first component 12. Similarly, the second sealing member 38 is positioned within the second recess 36 and has been compressed by the second component 14 to form a seal between the electrical connector 10 and the second component 14. According to one embodiment, the seals formed by the first and second sealing members 34, 38 prevent moisture and/or gas from migrating into the array portion 28 of the base 24 of the electrical connector 10. In addition, the first finger 60 of the electrical conductor 26 is connected to the first contact 18 of the first component 12 and the second finger 62 of the electrical conductor 26 is connected to the first contact 22 of the second component 14. The first finger 60 may be soldered or compression connected to the first contact 18 on the first component 12 and the second finger 62 may be soldered or compression connected to the first contact 22 on the second component 14.

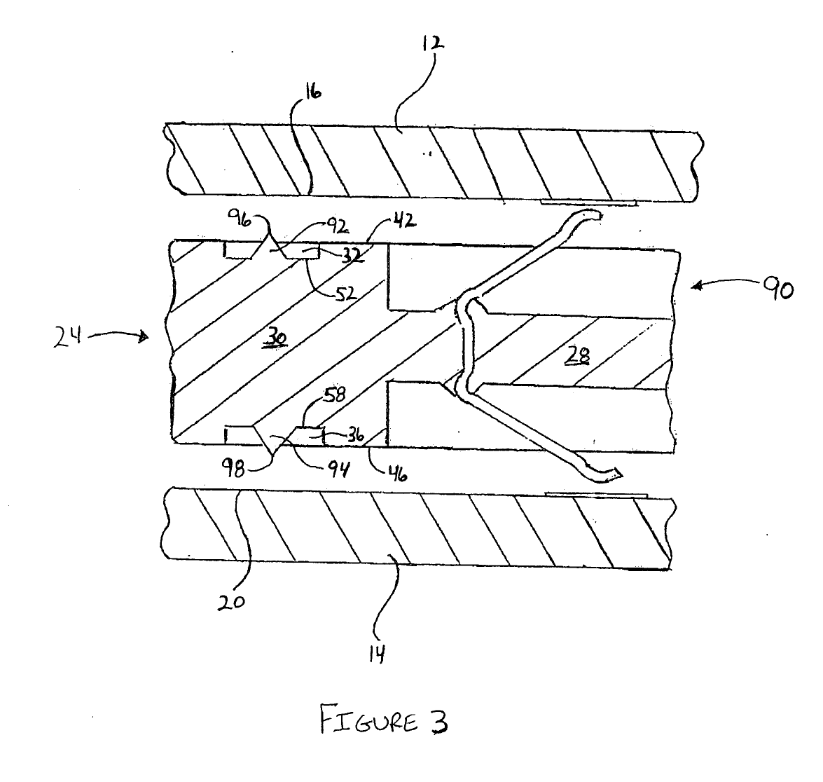

FIG. 3 is a side view of a portion of an electrical connector 90 according to another embodiment of the present invention. To facilitate the description of the electrical connector 90, a portion of a first component 12 and a portion of a second component 14 are also shown in FIG. 3, and the first and second components 12, 14 may be as described hereinabove.

The electrical connector 90 is similar to the electrical connector 10 of FIG. 1, but is different in that the perimeter portion 30 of the electrical connector 90 includes a first sealing member 92 connected to the first recess 32 and a second sealing member 94 connected to the second recess 36. The first sealing member 92 is connected to the first recess 32 such that when a first component 12 is connected to the electrical connector 90 the first sealing member 92 forms a seal between the electrical connector 90 and the first component 12. The second sealing member 94 is connected to the second recess 36 such that when a second component 14 is connected to the electrical connector 90 the second sealing member 94 forms a seal between the electrical connector 90 and the second component 14.

The first and second sealing members 92, 94 may be any type of sealing member suitable for forming a seal between two components when the two components are physically connected to one another. As shown in FIG. 3, the first sealing member 92 is a triangular shaped crush nub connected or molded into the floor 52 of the first recess 32 and includes a tip portion 96 which extends beyond the first surface 42 of the base 24. The second sealing member 94 is a triangular shaped crush nub connected or molded into the floor 58 of the second recess 36 and includes a tip portion 98 which extends beyond the second surface 46 of the base 24. According to one embodiment, the first sealing member 92 may extend beyond the first surface 42 of the base 24 by approximately 0.002 inches to 0.010 inches, and the second sealing member 94 may extend beyond the second surface 46 of the base 24 by approximately 0.002 inches to 0.010 inches.

According to another embodiment, the first sealing member 92 may be similar to the first sealing member 34 described hereinabove, and may also be molded or embedded into the floor 52 of the first recess 32. Similarly, the second sealing member 94 may be similar to the second sealing member 38 described hereinabove, and may also be molded or embedded into the floor 58 of the second recess 36.

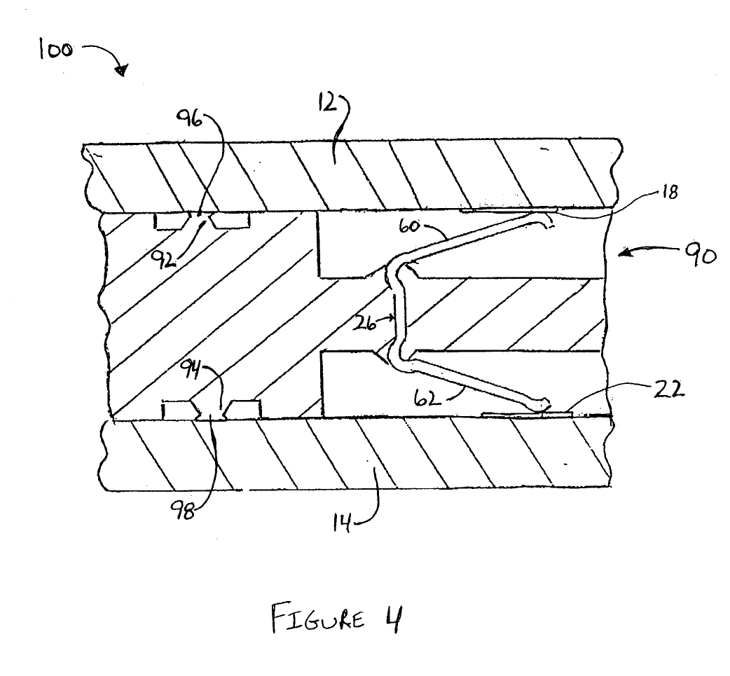

FIG. 4 is a side view of a portion of a system 100 which includes the electrical connector 90 of FIG. 3. The system 100 also includes a first component 12 connected to the first side 40 of the electrical connector 90 and a second component 14 connected to the second side 44 of the electrical connector 90. The first and second components 12, 14 may be as described hereinabove.

As shown in FIG. 4, the connection of the first component 12 to the first side 40 of the electrical connector 90 results in a deformation of the tip portion 96 of the first sealing member 92 such that the deformed tip portion 96 conforms to the contour of the first surface 16 of the first component 12 and forms a seal between the electrical connector 90 and the first component 12. Similarly, the connection of the second component 14 to the second side 44 of the electrical connector 90 results in a deformation of the tip portion 98 of the second sealing member 94 such that the deformed tip portion 98 conforms to the contour of the first surface 20 of the second component 14 and forms a seal between the electrical connector 90 and the second component 14. According to one embodiment, the seals formed by the first and second sealing members 92, 94 prevent moisture and gas from migrating into the array portion 28 of the base 24 of the electrical connector 90. In addition, the first finger 60 of the electrical conductor 26 is connected to the first contact 18 of the first component 12 and the second finger 62 of the electrical conductor 26 is connected to the first contact 22 of the second component 14. The first finger 60 may be soldered or compression connected to the first contact 18 on the first component 12 and the second finger 62 may be soldered or compression connected to the first contact 22 on the second component 14.

As described hereinabove, according to one embodiment, the first sealing member 92 may be a rubber o-ring or a rubber rectangular ring molded or embedded into the floor 52 of the first recess 32 and extending beyond the first surface 42 of the base 24. Similarly, the second sealing member 94 may be a rubber o-ring or a rubber rectangular ring molded or embedded into the floor 58 of the second recess 36 and extending beyond the second surface 46 of the base 24. In this embodiment, the connection of the first component 12 to the first side 40 of the electrical connector 90 results in a compression of the first sealing member 92 such that the first sealing member 92 conforms to the contour of the first surface 16 of the first component 12 and forms a seal between the electrical connector 90 and the first component 12. Similarly, the connection of the second component 14 to the second side 44 of the electrical connector 90 results in a compression of the second sealing member 94 such that the second sealing member 94 conforms to the contour of the first surface 20 of the second component 14 and forms a seal between the electrical connector 90 and the second component 14.

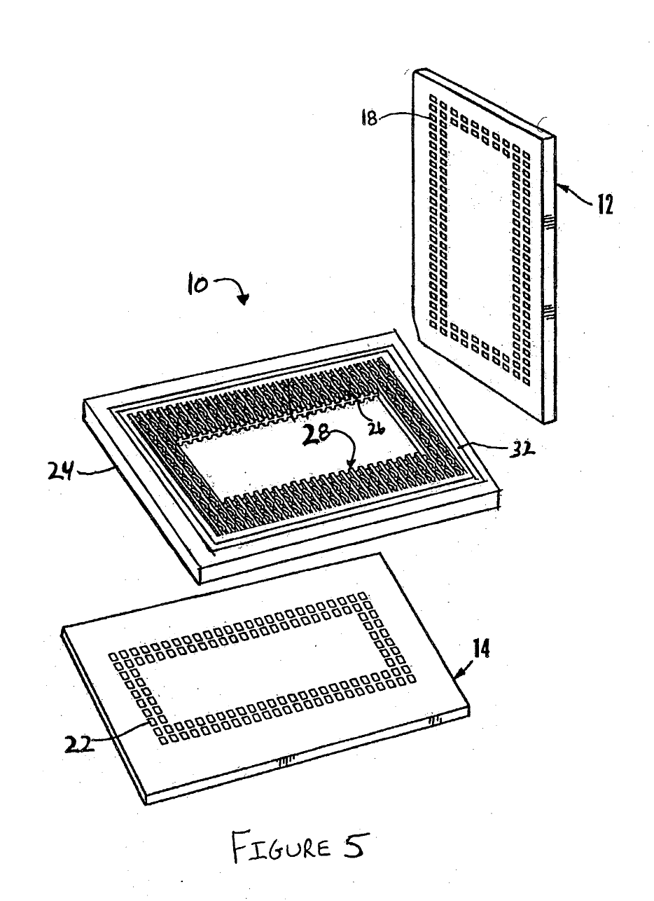

FIG. 5 is a perspective view of one embodiment of the electrical connector 10 of FIG. 1. To facilitate the description of the electrical connector 10, a first component 12 and a second component are also shown in FIG. 5. The first and second components 12, 14 may be as described hereinabove.

The array portion 28 of the electrical connector 10 includes a plurality of spaced apart electrical conductors 26 imbedded therein, and the array portion 28 isolates each electrical conductor 26 from the other electrical conductors 26. The first component 12 includes a plurality of spaced apart contacts 18 and the second component 14 includes a plurality of spaced apart contacts 22. In the embodiment illustrated, the contacts 18, 22 are positioned to coincide with the positions of the electrical conductors 26 when the first and second components 12, 14 are connected to the electrical connector 10. Thus, a particular electrical conductor 26 may establish an individual electrical circuit between one of the contacts 18 on the first component 12 and one of the contacts 22 on the second component 14. The plurality of contacts 18 on the first component 12 may constitute a land grid array, and the plurality of contacts 22 on the second component 14 may constitute another land grid array. Alternatively, the contacts 18, 22 on the first and second components 12, 14 can be constructed as balls or lands having a VIA hole as described hereinbelow.

As shown in FIG. 5, the first recess 32 of the perimeter portion 30 extends around the perimeter of the array portion 28 on the first side 40 of the electrical connector 10. According to one embodiment, the first recess 32 is structured and arranged to receive a plurality of first sealing members 34 such that when the first component 12 is connected to the electrical connector 10 the plurality of first sealing members 34 form a seal between the electrical connector 10 and the first component 12. For reasons of clarity, the first sealing members 34 are not shown in FIG. 5. For this embodiment, the plurality of first sealing members 34 may be connected together to ensure the integrity of the resulting seal.

Although not shown in FIG. 5, the second recess 36 extends around the perimeter of the array portion 28 on the second side 44 of the electrical connector 10. According to one embodiment, the second recess 36 is structured and arranged to receive a plurality of second sealing members 38 such that when the second component 14 is connected to the electrical connector 10 the plurality of second sealing members 38 form a seal between the electrical connector 10 and the second component 14. For this embodiment, the plurality of second sealing members 38 may be connected together to ensure the integrity of the resulting seal.

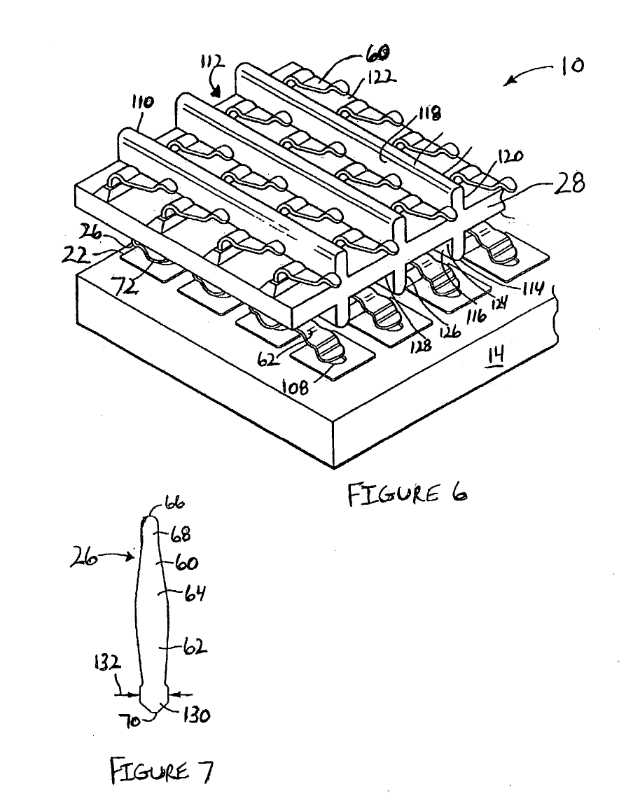

FIG. 6 is an enlarged view of a portion of the electrical connector 10 of FIG. 1. As shown, a plurality of electrical conductors 26 are imbedded into the array portion 28 of the base 24, and the second curled contact surface 72 of each of the electrical conductors 26 is in contact with a different contact 22 on second component 14. As shown in FIG. 6, one or more of the contacts 22 on the second component 14 may include a VIA hole 108.

The array portion 28 includes a plurality of substantially coplanar first surfaces 110 and a plurality of parallel first channels 112 which are positioned between the plurality of coplanar first surfaces 110. According to one embodiment, the coplanar first surfaces 110 of the array portion 28 are coplanar with the first surface 42 of the base 24. The array portion 28 also includes a plurality of substantially coplanar second surfaces 114 and a plurality of parallel second channels 116 which are positioned between the plurality of coplanar second surfaces 114. As shown in FIG. 6, each first channel 112 is aligned with a particular second channel 116.

Each first channel 112 includes a first wall 118, a second wall 120 and a bottom 122. According to one embodiment, the first and second walls 118, 120 and the bottom 122 of each first channel 112 are substantially flat. For each first channel 112, the first wall 118 extends from one of the coplanar first surfaces 110 of the array portion 28 to the bottom 122 of the particular first channel 112, and the second wall 120 extends from another one of the coplanar first surfaces 110 of the array portion 28 to the bottom 122 of the particular first channel 112. The first and second walls 118, 120 of each first channel 112 are substantially perpendicular to the coplanar first surfaces 110 of the array portion 28 and the bottom 122 of the particular first channel 112. Consequently, the bottom 122 of each first channel 112 is substantially parallel to the coplanar first surfaces 110 of the array portion 28.

Similarly, each second channel 116 includes a first wall 124, a second wall 126 and a bottom 128. According to one embodiment, the first and second walls 124, 126 and the bottom 128 of each second channel 116 are substantially flat. For each second channel 116, the first wall 124 extends from one of the coplanar second surfaces 114 of the array portion 28 to the bottom 128 of the particular second channel 116, and the second wall 126 extends from another one of the coplanar second surfaces 114 of the array portion 28 to the bottom 128 of the particular second channel 116. The first and second walls 124, 126 of each second channel 116 are substantially perpendicular to the coplanar second surfaces 1114 of the array portion 28 and the bottom 128 of the particular second channel 116. Consequently, the bottom 128 of each second channel 116 is substantially parallel to the coplanar second surfaces 114 of the array portion 28.

As shown in FIG. 6, the electrical conductors 26 can be closely spaced. According to one embodiment, the spacing from the midsection 64 of one electrical conductor 26 to the midsection 64 of an adjacent electrical conductor 26 can be on the order of less than 1.5 millimeters. The spacing from the first tip 66 of one electrical conductor 26 to the first tip 66 of an adjacent electrical conductor 26 can be on the order of 1.5 millimeters or less. Similarly, the spacing from the second tip 70 of one electrical conductor 26 to the second tip 70 of an adjacent electrical conductor 26 can be on the order of 1.5 millimeters or less.

FIG. 7 shows one embodiment of the electrical conductor 26 of the electrical connector 10 of FIG. 1. The electrical conductor 26 is shown as-stamped, before any shaping operations are performed thereon and before the electrical conductor 26 is imbedded into the base 24 to form the electrical connector 10. As described hereinabove, the electrical conductor 26 includes a first finger 60, a second finger 62 and a midsection 64 connecting the first finger 60 to the second finger 62. The first finger 60 extends from the midsection 64 and terminates in a first tip 66, and the second finger 62 extends from the midsection 64 and terminates in a second tip 70. As shown in FIG. 7, at least one end of the electrical conductor 26 may include a contact surface 130 having a suitable width 132 for bridging a VIA hole 108 such as, for example, one of the VIA holes 108 shown in FIG. 6.

While several embodiments of the invention have been described, it should be apparent, however, that various modifications, alterations and adaptations to those embodiments may occur to persons skilled in the art with the attainment of some or all of the advantages of the present invention. For example, although one embodiment shows the array portion 28 of the base 24 as having the first channels 112 aligned with the second channels 116, in other embodiments the first and second channels 112, 116 may be offset from one another. For this embodiment, the first and second fingers 60, 62 of each electrical conductor 26 may be offset from one another. In addition, although FIG. 5 shows a first recess 32 structured and arranged to receive a first sealing member 34 or a plurality of first sealing members 34, another embodiment of the present invention includes a first sealing member 92 or a plurality of first sealing members 92 connected to the first recess 34. It is therefore intended to cover all such modifications, alterations and adaptations without departing from the scope and spirit of the present invention as defined by the appended claims.

What is claimed is:

1. An electrical connector, comprising:
a base having an array portion and a perimeter portion connected to the array portion, wherein the perimeter portion includes a first recess structured and arranged to receive a first sealing member such that when a first component is connected to the electrical connector the first sealing member forms a seal between the electrical connector and the first component; and
an electrical conductor imbedded into the base.

2. The connector of claim 1, wherein the perimeter portion includes a second recess structured and arranged to receive a second sealing member such that when a second component is connected to the electrical connector the second sealing member forms a seal between the electrical connector and the second component.

3. The connector of claim 2, wherein the first recess is structured and arranged to receive a plurality of first sealing members such that when the first component is connected to the electrical connector the first sealing members form a seal between the electrical connector and the first component.

4. The connector of claim 2, wherein the second recess is structured and arranged to receive a plurality of second sealing members such that when the second component is connected to the electrical connector the second sealing members form a seal between the electrical connector and the second component.

5. The connector of claim 2, wherein the first recess is defined by a first surface of the base.

6. The connector of claim 5, wherein the second recess is defined by a second surface of the base.

7. The connector of claim 6, wherein the first surface is opposite the second surface.

8. The connector of claim 2, wherein at least one of the first and second sealing members is a rubber o-ring.

9. The connector of claim 2, wherein at least one of the first and second sealing members is a rubber rectangular ring.

10. The connector of claim 2, wherein the electrical conductor is imbedded into the array portion of the base.

11. The connector of claim 10, wherein a plurality of electrical conductors are imbedded into the array portion of the base.

12. The connector of claim 2, wherein the electrical conductor includes a first finger extending beyond a first surface of the base and a second finger extending beyond a second surface of the base.

13. An electrical connector, comprising:
a base having an array portion and a perimeter portion connected to the array portion, wherein the perimeter portion is formed with a first recess and includes a first sealing member connected to the first recess such that when a first component is connected to the electrical connector the first sealing member forms a seal between the electrical connector and the first component; and
an electrical conductor imbedded into the base.

14. The connector of claim 13, wherein the perimeter portion is formed with a second recess and includes a second sealing member connected to the second recess such that when a second component is connected to the electrical connector the second sealing member forms a seal between the electrical connector and the second component.

15. The connector of claim 14, wherein perimeter portion includes a plurality of first sealing members connected to the first recess such that when the first component is connected to the electrical connector the first sealing members form a seal between the electrical connector and the first component.

16. The connector of claim 14, wherein the perimeter portion includes a plurality of second sealing members connected to the second recess such that when the second component is connected to the electrical connector the second sealing members form a seal between the electrical connector and the second component.

17. The connector of claim 14, wherein the first recess is defined by a first surface of the base.

18. The connector of claim 17, wherein the second recess is defined by a second surface of the base.

19. The connector of claim 18, wherein the first surface is opposite the second surface.

20. The connector of claim 14, wherein the first sealing member extends beyond a first surface of the base and the second sealing member extends beyond a second surface of the base.

21. The connector of claim 14, wherein at least one of the first and second sealing members is a crushable nub.

22. The connector of claim 21, wherein the crushable nub is a triangular-shaped crushable nub.

23. The connector of claim 14, wherein at least one of the first and second sealing members is a rubber o-ring.

24. The connector of claim 14, wherein at least one of the first and second sealing members is a rubber rectangular ring.

25. The connector of claim 14, wherein the electrical conductor is imbedded into the array portion of the base.

26. The connector of claim 25, wherein a plurality of electrical conductors are imbedded into the array portion of the base.

27. The connector of claim 14, wherein the electrical conductor includes a first finger extending beyond a first surface of the base and a second finger extending beyond a second surface of the base.

28. A system, comprising:
an electrical connector, wherein the electrical connector includes:
a base having an array portion and a perimeter portion connected to the array portion, wherein the perimeter portion includes first and second recesses; and
an electrical conductor imbedded into the base;
first and second components connected to the electrical connector;
a first sealing member positioned within the first recess and forming a seal between the electrical connector and the first component; and
a second element positioned within the second recess and forming a seal between the electrical connector and the second component.

29. A system, comprising:
an electric connector; and
first and second components connected to opposite sides of the electrical connector, wherein the electrical connector includes:
a base having an array portion and a perimeter portion connected to the array portion, wherein the perimeter portion includes:
a first sealing member connected to a first recess of the perimeter portion and forming a seal between the electrical connector and the first component; and
a second sealing member connected to a second recess of the perimeter portion and forming a seal between the electrical connector and the second component; and
an electrical conductor imbedded into the base.
